(19) United States
(12) Patent Application Publication
(10) Pub. No.: US 2020/0287237 A1
(43) Pub. Date: Sep. 10, 2020

(54) Copper Ionic Conductor Film

(71) Applicant: International Business Machines Corporation, Armonk, NY (US)

(72) Inventors: Teodor K. Todorov, Yorktown Heights, NY (US); Douglas M. Bishop, New York, NY (US); John Collins, Tarrytown, NY (US); Frances M. Ross, Stamford, CT (US)

(21) Appl. No.: 16/296,027

(22) Filed: Mar. 7, 2019

(51) Int. Cl. H01M 10/0562; H01G 11/56; H01M 10/0525

(52) U.S. Cl. CPC H01M 10/0562; H01M 10/0525; H01G 11/56

(57) ABSTRACT

Copper ionic conductor films and method of making the same are provided. In one aspect, a method of forming a crystalline ionic conductor film includes: depositing a mixture of sources for components of the crystalline ionic conductor film onto a substrate, the components including: i) Cu, ii) a component A selected from: Rb, Cs, K, Na and/or Li, and iii) a component B selected from: F, Cl, Br and/or I; and annealing the mixture under conditions sufficient to form the crystalline ionic conductor film on the substrate having a formula: CuₓA_{y}B_{z}, wherein 0<x<20, 0<y<10, and 0<z<30. A device having a crystalline ionic conductor film as an electrolyte and method of forming the device are also provided.

### FIELD OF THE INVENTION

The present invention relates to solid ionic conductors with high conductivity, and more particularly, to improved copper ionic conductor films and method of making the same.

### BACKGROUND OF THE INVENTION

Thin film room temperature solid ionic conductors with high conductivity are needed for next generation computing applications. Copper ionic conductors have been investigated for a variety of different applications including use as a solid electrolyte in microbatteries. These copper ionic conductors have been prepared mostly by bulk synthesis routes involving grinding, annealing and pressing powders. See, for example, T. E. Warner, “Synthesis, Properties and Mineralogy of Important Inorganic Materials, Chapter 6, Rubidium Copper Iodide Chloride Rb₄Cu₁₆I₇Cl₁₃ by a Solid-State Reaction,” John Wiley & Sons, Ltd., (April 2011) (10 pages).

Cu₁₆Rb₄I₇Cl₁₃ was claimed to have the highest room temperature ionic conductivity among all superionic conductors (0.34 Siemen per centimeter (S/cm)). See, for example, Takahashi et al., “Solid-State Ionics: High Copper Ion Conductivity of the System CuCl-Cul-RbCl,” Journal of The Electrochemical Society, Vol. 126, No. 10, 1979, pp. 1654-1658 (hereinafter “Takahashi”). However bulk powder synthesis as described in Takahashi is not directly transferable to microfabrication. Further, the control of precise stoichiometry of multi-element thin films is challenging by standard techniques such as co-evaporation.

Thus, improved techniques for forming copper ionic conductor films would be desirable.

### SUMMARY OF THE INVENTION

The present invention provides improved copper ionic conductor films and method of making the same. In one aspect of the invention, a method of forming a crystalline ionic conductor film is provided. The method includes: depositing a mixture of sources for components of the crystalline ionic conductor film onto a substrate, the constituent components including: i) copper (Cu), ii) a component A selected from: rubidium (Rb), caesium (Cs), potassium (K), sodium (Na) and/or lithium (Li), and iii) a component B selected from: fluorine (F), chlorine (Cl), bromine (Br) and/or iodine (I); and annealing the mixture under conditions sufficient to form the crystalline ionic conductor film on the substrate including a metal halide having a formula: CuₓA_{y}B_{z}, wherein 0<x<20, 0<y<10, and 0<z<30. The conditions preferably include a temperature that is less than a melting point of the mixture of the constituent components. For instance, the conditions can include a temperature of from about 50° C. to about 200° C. and ranges therebetween, and a duration of from about 2 minutes to about 360 minutes and ranges therebetween.

The crystalline ionic conductor film formed can have an ionic conductivity of greater than about 0.34 Siemens per centimeter (S/cm). For instance, the crystalline ionic conductor film can have an ionic conductivity of from about 0.34 S/cm to about 1 S/cm and ranges therebetween.

In another aspect of the invention, a method of forming a device is provided. The method includes: providing a substrate including a cathode; forming an electrolyte on the substrate by: depositing a mixture of constituent components onto a substrate, the constituent components including: i) Cu, ii) a component A selected from: Rb, Cs, K, Na and/or Li, and iii) a component B selected from: F, Cl, Br and/or I; and annealing the mixture under conditions sufficient to form a crystalline ionic conductor film as the electrolyte on the substrate including a metal halide having a formula: CuₓA_{y}B_{z}, wherein 0<x<20, 0<y<10, and 0<z<30; and forming an anode on the electrolyte.

In yet another aspect of the invention, a device is provided. The device includes: a substrate including a cathode; an electrolyte disposed on the substrate, the electrolyte including a crystalline ionic conductor film having a formula: CuₓA_{y}B_{z}, wherein A is selected from: Rb, Cs, K, Na and/or Li, wherein B is selected from: F, Cl, Br and/or I, and wherein 0<x<20, 0<y<10, and 0<z<30; and an anode disposed on the electrolyte.

A more complete understanding of the present invention, as well as further features and advantages of the present invention, will be obtained by reference to the following detailed description and drawings.

### BRIEF DESCRIPTION OF THE DRAWINGS

FIG. 1 is a diagram illustrating an exemplary methodology for forming an ionic conductor film according to an embodiment of the present invention;

FIG. 2 is a cross-sectional diagram illustrating a substrate (including a cathode) having been placed in a glove box along with a mixture prepared in accordance with the methodology of FIG. 1 according to an embodiment of the present invention;

FIG. 3 is a cross-sectional diagram illustrating the mixture having been deposited onto the substrate forming a precursor film on the substrate according to an embodiment of the present invention;

FIG. 4 is a cross-sectional diagram illustrating the precursor film being annealed at a temperature that is less than a melting point of the mixture to form a homogenous, crystalline ionic conductor film (solid electrolyte) on the substrate according to an embodiment of the present invention;

FIG. 5 is a cross-sectional diagram illustrating an anode having been formed on the crystalline ionic conductor film according to an embodiment of the present invention; and

FIG. 6 is a cross-sectional diagram illustrating top (negative) electrode having been formed on the anode according to an embodiment of the present invention.

### DETAILED DESCRIPTION OF PREFERRED EMBODIMENTS

Provided herein are techniques for fabricating device-ready thin-films with improved Cu+ ionic conductivity. While the following description uses the fabrication of copper (Cu) ionic conductor films as an illustrative example, it is to be understood that the present techniques are broadly applicable to any halide system wherein unfavorable phase formation or segregation during crystallization from melt can occur, especially in the case of mixtures of multiple components with different melting points.

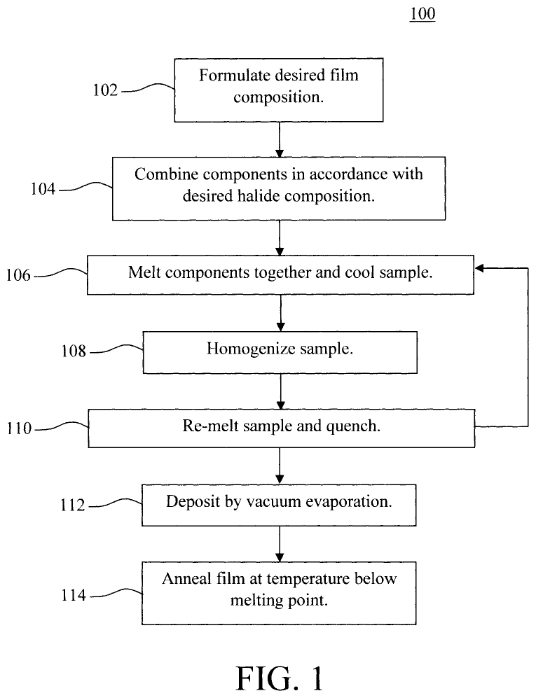

An exemplary process for forming an ionic conductor film in accordance with the present techniques is now described by way of reference to methodology 100 of FIG. 1. According to an exemplary embodiment, the steps of methodology 100 are carried out in a glove box with a controlled environment. For instance, the glove box can contain an ambient of inert gas such as nitrogen and/or argon, i.e., also referred to herein as a nitrogen- or argon-filled glove box. Further, the glove box can contain a vacuum chamber for processing the sample in a vacuum.

According to an exemplary embodiment, the ionic conductor film is a metal halide having the formula:

CuₓA_{y}B_{z}, (1)

wherein A is at least one metal selected from rubidium (Rb), caesium (Cs), potassium (K), sodium (Na), and lithium (Li), wherein B is at least one halogen selected from fluorine (F), chlorine (Cl), bromine (Br) and iodine (I), and wherein 0<x<20, 0<y<10, and 0<z<30. For instance, according to one exemplary embodiment, the ionic conductor formed is a rubidium copper iodide chloride film having the formula Rb₄Cu₁₆I₇Cl₁₃.

The ionic conductor films formed using the present techniques have a high ionic conductivity. For instance, according to an exemplary embodiment, the ionic conductor film formed via methodology 100 has an ionic conductivity of greater than about 0.34 Siemens per centimeter (S/cm), for example, from about 0.34 S/cm to about 1 S/cm and ranges therebetween.

To begin the process, a desired composition of the ionic conductor film is formulated. See step 102. For instance, using formulation 1 above as an example, in addition to Cu a selection of the constituent components A (i.e., Rb, Cs, K, Na and/or Li) and B (i.e., F, Cl, Br and/or I) (in addition to Cu) can be made in step 102. In accordance with this desired composition, source compounds of the constituent components are then combined in a suitable vessel such as a glass vial. See step 104. By way of example only, suitable source compounds include, but are not limited to, copper fluoride (CuF₂), copper bromide (CuBr₂), copper iodide (Cup, copper chloride (CuCl₂), rubidium fluoride (RbF), rubidium bromide (RbBr), rubidium iodide (RbI), rubidium chloride (RbCl), caesium fluoride (CsF), caesium bromide (CsBr), caesium iodide (CsI), caesium chloride (CsCl), potassium fluoride (KF), potassium bromide (KBr), potassium iodide (KI), potassium chloride (KCl), sodium fluoride (NaF), sodium bromide (NaBr), sodium iodide (Nap, sodium chloride (NaCl), lithium fluoride (LiF), lithium bromide (LiBr), lithium iodide (Lip and/or lithium chloride (LiCl). These compounds are commercially available in a powder or other solid form, and the appropriate amounts of each can be combined in the vessel to form a blend of the compounds.

Determining the appropriate amounts of each source compound needed for a particular final composition to achieve the desired final atomic ratio is a straightforward process. For instance, using a sample material with the desired final composition as a guide, chemical analysis of the sample by techniques including, but not limited to, inductively coupled plasma (ICP) analysis can be used to determine the ratio of the source compounds in the sample. Further, any deviations from the desired ratio due to possible elemental loss during processing can be adjusted accordingly by adding excess of the deficient element in the source material. For illustrative purposes only, according to one exemplary embodiment, a rubidium copper iodide chloride film is produced using the source compounds: CuCl, CuI, and RbCl. To use an illustrative, non-limiting example, when it is desirable to produce a rubidium copper iodide chloride film having the formula Rb₄Cu₁₆I₇Cl₁₃, the system formulation includes 0.9 millimole (mmol) CuCl, 0.7 mmol CuI, and 0.4 mmol RbCl. Further, as this example highlights, the constituent components preferably include at least one compound (e.g., in this case three different compounds, i.e., CuCl, CuI and RbCl) that are sources for Cu, component A, component B, etc.—see formulation 1, above. The term “compound,” as used herein, refers to a combination of elements (e.g., in a fixed ratio) as opposed to the individual elements themselves.

In step 106, annealing is performed to melt the blend. According to an exemplary embodiment, the annealing is performed at a temperature of from about 200° C. to about 350° C. and ranges therebetween, for a duration of from about 1 minute to about 10 minutes and ranges therebetween, or until the mixture has fully melted in the vessel. According to an exemplary embodiment, the annealing is performed by placing the vessel containing the blend on a hot plate or other suitable heat source. Once melted, the heat is removed, and the blend is permitted to gradually cool back down to room temperature.

The cooling forms a solid product in the vessel. In step 108, the solid product is ground into a powder. According to an exemplary embodiment, the solid product is ground into a powder using a planetary ball mill such as the Planetary Ball Mill PM 100 available from Retsch GmbH, Haan, Germany. A solvent such as toluene or benzene can be employed as a dispersing agent. A mixer can then be used to homogenize the powder. Suitable powder mixers are commercially available, for example, from Hosokawa Micron Powder Systems, Summit, N.J.

Annealing is then performed to re-melt the (now homogenized) powder to form a melted product. See step 110. In this case, however, the anneal is followed by a quenching where the melted product is rapidly cooled. Rapid quenching helps form the crystalline structure of the (now solid, quenched) sample. For instance, according to an exemplary embodiment, the annealing is performed at a temperature of from about 200° C. to about 350° C. and ranges therebetween, for a duration of from about 1 minute to about 10 minutes and ranges therebetween, or until the sample has fully melted. The annealing is then immediately followed by a quench. By way of example only, the quenching is performed at a ramp-down rate of from about 50° C./second to about 100° C./second and ranges therebetween.

In one exemplary, non-limiting implementation of the present techniques, step 110 is performed using resistive heating. For instance, the powder (or a portion thereof) from step 108 is placed in a metal foil boat or similarly-shaped electrically-conductive vessel. To use an illustrative, non-limiting example, step 110 can be carried out using a tungsten (W) foil boat, and an amount of from about 50 milligrams (mg) to about 100 mg and ranges therebetween of the homogenized powder (from step 108) is transferred to the metal foil boat.

A current is then applied to the metal foil boat which, via resistive heating, heats the metal foil boat and thus the powder within the metal foil boat. According to an exemplary embodiment, a current of from about 10 Amps to about 20 Amps and ranges therebetween is employed. This resistive heating serves to melt the powder within the metal foil boat. The melted sample is then quickly quenched by removing the current from the metal foil boat. The quenching results in a solid product fused to the metal foil boat. In the case of a Cu halide system, this solid has a distinctive bright yellow color.

Optionally, steps 106-110 can be repeated multiple times. See FIG. 1. Performing multiple iterations of the melting, grinding, and melting/quenching can increase the uniformity of the crystal structure of the sample. Namely, by way of example only, the solid product from the metal foil boat can again be melted and allowed to slowly cool (as per step 106), ground into a powder (as per step 108) and then re-melted and quenched (as per step 110). After each iteration, the crystal structure of the sample can be analyzed using a process such as x-ray diffraction. Steps 106-110 can be repeated until the x-ray diffraction pattern of the sample does not change from one iteration to the next. See, for example, Takahashi.

The (solid) product from step 110 is composed of a mixture of the source compounds. In step 112, the mixture is then deposited as a film onto a substrate. For instance, when the ionic conductor film is being used as a solid electrolyte in a solid-state battery, the substrate can be an anode or cathode on which the solid electrolyte is formed. However, as highlighted above, the present techniques are applicable to the formation of an ionic conductor film for a variety of different applications.

According to an exemplary embodiment, the mixture is deposited onto the substrate using a vacuum evaporation process. With vacuum evaporation, the mixture is heated to form a vapor. The presence of a vacuum enables the vapor to condense on the substrate. In one exemplary, non-limiting example, the vacuum evaporation is carried out at a pressure of less than about 2×10⁻⁵ torr, e.g., from about 1×10⁻⁵ torr to about 1.5×10⁻⁵ torr and ranges therebetween. If the mixture is present in the metal foil boat, resistive heating can again be employed via an applied current to the metal foil boat. For instance, in one exemplary embodiment the applied current is ramped from about 15 Amps to about 25 Amps at a rate of from about 4 Amps/minute (A/min) to about 5 A/min and ranges therebetween, and then from about 25 Amps to about 35 Amps at a rate of from about 8 A/min to about 10 A/min and ranges therebetween, which results in complete evaporation of the material.

The mixture deposited in this manner, however, does not have a homogenous composition. Advantageously, it has been found herein that next annealing the mixture at a temperature that is less than a melting point of the mixture will result in the formation of a homogenous, crystalline ionic conductor film on the substrate. Thus, in step 114, the mixture is annealed under conditions (e.g., temperature, duration, etc.) sufficient to form a homogenous, crystalline ionic conductor film on the substrate. For instance, according to an exemplary embodiment, in step 114 the mixture is annealed at a temperature of from about 50° C. to about 200° C. and ranges therebetween, for a duration of from about 2 minutes to about 360 minutes and ranges therebetween.

For instance, using formulation 1 above as an example, annealing the mixture at a temperature that is less than a melting point of the mixture will result in the formation of a crystalline ionic conductor film on the substrate having the formula CuₓA_{y}B_{z}, wherein 0<x<20, 0<y<10, and 0<z<30.

The present techniques are now implemented in an exemplary embodiment for forming a device. In the example, a battery is formed where the ionic conductor film serves as a solid electrolyte between an anode and cathode. However, as provided above, the present techniques are applicable to a variety of different applications. Thus, the example that follows is a non-limiting example provided merely to illustrate the present techniques.

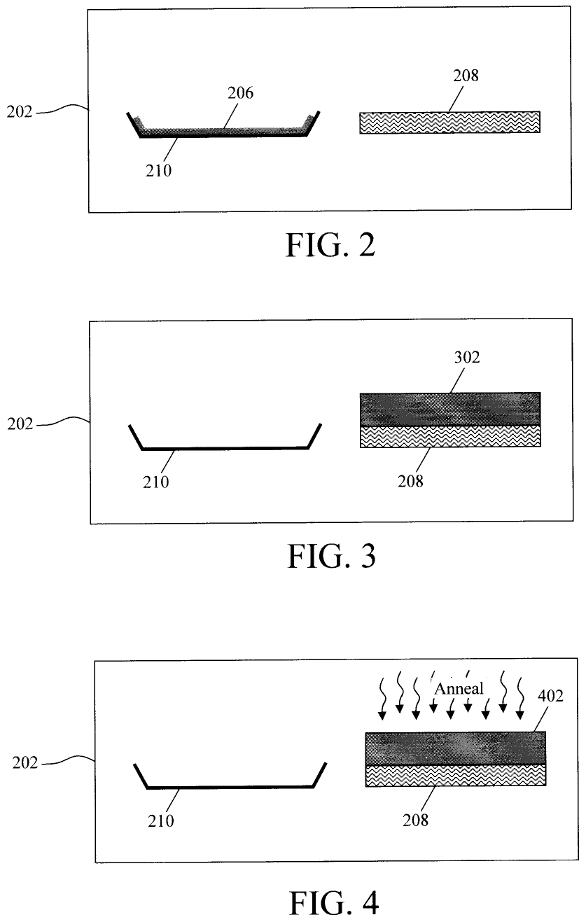

As shown in FIG. 2, the process is carried out in a controlled environment, such as a vacuum glove box 202. As provided above, the glove box 202 can contain an ambient of inert gas such as nitrogen and/or argon.

A substrate 208 is placed in the glove box 202 along with a mixture 206 prepared in accordance with methodology 100. Namely, as described above, the mixture 206 is prepared in accordance with a desired ionic conductor film composition—see formulation 1 (step 102) by blending source compounds of the constituent components together (step 104) and melting the blend (step 106). For instance, in one exemplary, non-limiting embodiment a rubidium copper iodide chloride film is produced using the compounds: copper chloride (CuCl), copper iodide (Cup, and rubidium chloride (RbCl), as sources of Cu, component A, component B, etc.—see formulation 1, above. The melted blend is permitted to cool gradually forming a solid product, which is then ground into a powder (step 108) that is re-melted and quickly quenched (step 110).

The product is a mixture of the source compounds that will be used to form the ionic conductor film on the substrate 204. For instance, according to an exemplary embodiment, the mixture contains source compounds of the constituent components: i) Cu, ii) a component A which is at least one metal selected from Rb, Cs, K, Na, and/or Li, and iii) a component B which is at least one halogen selected from F, Cl, Br and/or I. As provided above, the melting/quenching can be performed via resistive heating using a metal foil boat. In that case, the mixture 206 placed in the glove box 202 with the substrate 208 is fused to the metal foil boat 210.

According to an exemplary embodiment, the substrate 208 includes a cathode used in the formation of a microbattery. See, for example, U.S. patent application Ser. No. 15/871,488 by Brew et al., entitled “Low-Voltage Microbattery” (hereinafter “application Ser. No. 15/871,488”), the contents of which are incorporated by reference as if fully set forth herein. As described in application Ser. No. 15/871,488, the formation of a microbattery can begin with a cathode formed on an electrically-conductive or electrically non-conductive substrate. Suitable electrically-conductive substrates include, but are not limited to, metal foils such as copper, vanadium, steel, aluminum, and/or nickel foils. In that case, the substrate itself serves as the bottom (positive) electrode of the battery. However, when formed from an electrically non-conductive material such as glass, ceramics, polymers, semiconductors, the substrate is coated with a contact metals such as copper, vanadium, steel, aluminum, indium, and/or nickel to form the bottom (positive) electrode of the battery prior to depositing the cathode. See application Ser. No. 15/871,488.

The cathode of the battery is then formed on the substrate. Suitable cathode materials include, but are not limited to, intercalated materials such as molybdenum disulfide (MoS₂), digenite (Cu_{1.8}S) and/or copper molybdenum sulfide (CuₓMo₆S_{7.8}) (see, e.g., Kanno et al., “Rechargeable all solid-state cell with high copper ion conductor and copper chevrel phase,” Materials Research Bulletin, Volume 22, Issue 9, September 1987, Abstract (1 page) (hereinafter “Kanno”), the contents of which are incorporated by reference as if fully set forth herein).

Referring to FIG. 3, the mixture from the metal foil boat 210 is then deposited onto the substrate 208 (as per step 112) forming a precursor film 302 on the substrate 208. According to an exemplary embodiment, the mixture is deposited onto the substrate 208 using a vacuum evaporation process. In one exemplary, non-limiting example, the vacuum evaporation is carried out at a pressure of less than about 2×10⁻⁵ torr, e.g., from about 1×10⁻⁵ torr to about 1.5×10⁻⁵ torr and ranges therebetween. As described above, if the mixture is present in the metal foil boat 210, then resistive heating can again be employed via an applied current to the metal foil boat 210. For instance, according to an exemplary embodiment, the applied current is ramped from about 15 Amps to about 25 Amps at a rate of from about 4 A/min to about 5 A/min and ranges therebetween, and then from about 25 Amps to about 35 Amps at a rate of from about 8 A/min to about 10 A/min and ranges therebetween, which results in complete evaporation of the material.

As described above, the precursor film 302 deposited in this manner onto the substrate 208 does not have a homogenous composition. However, next annealing the precursor film 302 at a temperature that is less than a melting point of the mixture will result in the formation of a homogenous, crystalline ionic conductor film 402 on the substrate. See FIG. 4. According to an exemplary embodiment, the precursor film 302 is annealed at a temperature of from about 50° C. to about 200° C. and ranges therebetween, for a duration of from about 2 minutes to about 360 minutes and ranges therebetween.

For instance, using formulation 1 above as an example, annealing the mixture at a temperature that is less than a melting point of the mixture will result in the formation of a crystalline ionic conductor film 402 on the substrate 208 having the formula CuₓA_{y}B_{z}, wherein 0<x<20, 0<y<10, and 0<z<30. In the instant example, crystalline ionic conductor film 402 serves as the solid electrolyte of the microbattery.

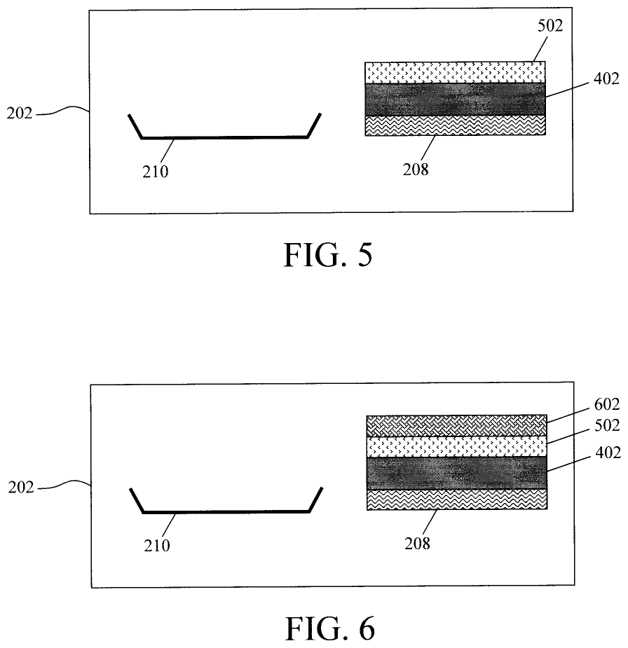

An anode 502 is then formed on the crystalline ionic conductor film 402. See FIG. 5. Suitable materials for the anode 502 include, but are not limited to, copper (Cu)-based materials such as Cu_{1.8}S and/or CuₓMo₆S_{7.8}.

A top (negative) electrode 602 of the battery is then formed on the anode 502. See FIG. 6. Suitable contact metals for forming the top (negative) electrode 602 include, but are not limited to, copper, vanadium, steel, aluminum, indium, and/or nickel. See application Ser. No. 15/871,488.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A method of forming a crystalline ionic conductor film, the method comprising the steps of:
depositing a mixture of sources for components of the crystalline ionic conductor film onto a substrate, the components comprising: i) copper (Cu), ii) a component A selected from the group consisting of: rubidium (Rb), caesium (Cs), potassium (K), sodium (Na), lithium (Li), and combinations thereof, and iii) a component B selected from the group consisting of: fluorine (F), chlorine (Cl), bromine (Br), iodine (I), and combinations thereof; and
annealing the mixture under conditions sufficient to form the crystalline ionic conductor film on the substrate comprising a metal halide having a formula:
CuₓA_{y}B_{z},
wherein 0<x<20, 0<y<10, and 0<z<30.

2. The method of claim 1, wherein the conditions comprise a temperature that is less than a melting point of the mixture.

3. The method of claim 1, wherein the conditions comprise a temperature of from about 50° C. to about 200° C. and ranges therebetween.

4. The method of claim 1, wherein the conditions comprise a duration of from about 2 minutes to about 360 minutes and ranges therebetween.

5. The method of claim 1, wherein the ionic conductor film comprises rubidium copper iodide chloride.

6. The method of claim 5, wherein the rubidium copper iodide chloride has a formula Rb₄Cu₁₆I₇Cl₁₃.

7. The method of claim 1, wherein the crystalline ionic conductor film has an ionic conductivity of greater than about 0.34 Siemens per centimeter (S/cm).

8. The method of claim 1, wherein the crystalline ionic conductor film has an ionic conductivity of from about 0.34 S/cm to about 1 S/cm and ranges therebetween.

9. The method of claim 1, wherein the steps are performed in an ambient of inert gas.

10. The method of claim 9, wherein the inert gas is selected from the group consisting of: nitrogen, argon, and combinations thereof.

11. The method of claim 1, wherein the mixture is deposited onto the substrate using a vacuum evaporation process.

12. The method of claim 1, wherein the sources are selected from the group consisting of: copper fluoride (CuF₂), copper bromide (CuBr₂), copper iodide (CuI), copper chloride (CuCl₂), rubidium fluoride (RbF), rubidium bromide (RbBr), rubidium iodide (RbI), rubidium chloride (RbCl), caesium fluoride (CsF), caesium bromide (CsBr), caesium iodide (CsI), caesium chloride (CsCl), potassium fluoride (KF), potassium bromide (KBr), potassium iodide (KI), potassium chloride (KCl), sodium fluoride (NaF), sodium bromide (NaBr), sodium iodide (NaI), sodium chloride (NaCl), lithium fluoride (LiF), lithium bromide (LiBr), lithium iodide (LiI), lithium chloride (LiCl), and combinations thereof.

13. The method of claim 1, further comprising the step of:
combining the sources to form a blend.

14. The method of claim 13, further comprising the steps of:
melting the blend;
cooling the blend to form a solid product;
grinding the solid product into a powder;
re-melting the powder to form a melted product; and
quenching the melted product to form the mixture of the sources.

15. The method of claim 14, further comprising the step of:
repeating the melting, cooling, grinding, re-melting and quenching.

16. The method of claim 14, wherein the melting is performed at a temperature of from about 200° C. to about 350° C. and ranges therebetween, for a duration of from about 1 minute to about 10 minutes and ranges therebetween.

17. A method of forming a device, the method comprising the steps of:
providing a substrate comprising a cathode;
forming an electrolyte on the substrate by: depositing a mixture of sources for components of the crystalline ionic conductor film onto a substrate, the components comprising: i) Cu, ii) a component A selected from the group consisting of: Rb, Cs, K, Na, Li, and combinations thereof, and iii) a component B selected from the group consisting of: F, Cl, Br, I, and combinations thereof; and annealing the mixture under conditions sufficient to form a crystalline ionic conductor film as the electrolyte on the substrate comprising a metal halide having a formula: CuₓA_{y}B_{z}, wherein 0<x<20, 0<y<10, and 0<z<30; and
forming an anode on the electrolyte.

18. The method of claim 17, wherein the conditions comprise a temperature that is less than a melting point of the mixture.

19. A device, comprising:
a substrate comprising a cathode;
an electrolyte disposed on the substrate, the electrolyte comprising a crystalline ionic conductor film having a formula: CuₓA_{y}B_{z}, wherein A is selected from the group consisting of: Rb, Cs, K, Na, Li, and combinations thereof, wherein B is selected from the group consisting of: F, Cl, Br, I, and combinations thereof, and wherein 0<x<20, 0<y<10, and 0<z<30; and
an anode disposed on the electrolyte.

20. The device of claim 19, wherein the crystalline ionic conductor film has an ionic conductivity of greater than about 0.34 S/cm.
